(19) United States
(12) Patent Application Publication
(10) Pub. No.: US 2015/0326645 A1
(43) Pub. Date: Nov. 12, 2015

(54) METHOD FOR CONTROLLING PROGRAM SHARING BY PLURALITY OF TERMINALS

(71) Applicant: Gahyung RHEE, Wanju-gun Jeollabuk-do (KR)

(72) Inventor: Gahyung RHEE, Jeollabuk-do (KR)

(21) Appl. No.: 14/360,651

(22) PCT Filed: Nov. 28, 2012
(86) PCT No.: PCT/KR2012/010193

§ 371 Date: May 27, 2014

(30) Foreign Application Priority Data
Nov. 29, 2011 (KR) 10-2011-0125661

(51) Int. Cl. H04L 29/08; G06F 3/0482; H04L 12/24

(52) U.S. Cl. CPC H04L 67/10; H04L 41/22; G06F 3/0482

(57) ABSTRACT

Disclosed is a method for controlling program sharing by a plurality of terminals. The method for controlling program sharing by a plurality of terminals comprises the steps of: linking a main terminal and a sub terminal; transmitting program information executed in the main terminal to the sub terminal; sharing items related to a program; allowing a first item shared by the main terminal to be processed by the main terminal, or allowing a second item shared by the sub terminal to be processed by the sub terminal; transmitting a command related to the processed first item to the sub terminal, or a command related to the processed second item to the main terminal.

### BACKGROUND

1. Field

The following description relates to a program divisional controlling method by multiple terminals, more particularly, to a method for processing items necessary in driving a program, the processing of the items being divided to be performed by a plurality of terminals.

2. Description of Related Art

The technology of using a touch screen method in selecting a GUI item such as an icon, menu, or anchor etc. has already become a common technology. And in such an environment where a touch screen method is used, selecting a command from a menu has been the general method for executing the command.

To execute a command from a menu, it is necessary to conduct a manipulation to provide the state where a menu screen can be called, manipulation of calling a menu screen, manipulation for moving from the menu screen to a screen where a desired command is displayed, and a manipulation of selecting a command etc.

However, due to the characteristics of a touch screen, it is true that viewing the screen may be interfered or arithmetic operations under execution may be burdened when the aforementioned manipulations are conducted.

Furthermore, since a terminal having a touch screen interface is generally a portable terminal, it is true that certain loss has to be accepted in terms of performance such as the processor or memory, for realization of the original purpose, that is the realization of an ultra-thin terminal.

### SUMMARY

Therefore, the purpose of the present disclosure is to resolve the aforementioned problems of prior art, that is to provide a program divisional controlling method by multiple terminals, wherein functions may be divided and shared by a plurality of terminals, thereby reducing the amount of arithmetic operations to be conducted in a terminal while still utilizing the characteristics of the terminal having a touch screen interface.

In one general aspect, there is provided a divisional controlling method by multiple terminals, the method comprising: interlocking a main terminal and at least one sub terminal; transmitting program information executed in the main terminal to the sub terminal; dividing items related to the program into items to be processed by the main terminal and items to be processed by the sub terminal; processing by the main terminal first items that are items divided to be processed by the main terminal, or processing by the sub terminal second items that are items divided to be processed by the sub terminal; and transmitting a command related to the processed first items to the sub terminal, or transmitting a command related to the processed second items to the main terminal.

Herein, the items related to the program may comprise at least some of a menu, tool, setting, and interface that is usable in the program, processing regarding the program, and sub program regarding the program.

Furthermore, when the second items divided to be processed in the sub terminal is a menu, the menu may be changed based on a state of the program executed in the sub terminal or the main terminal and be displayed on a screen of the sub terminal.

Furthermore, when the second items divided to be processed in the sub terminal is part of a menu, the menu may be displayed on a screen of the sub terminal, and the rest of the menu may be displayed on a screen of the main terminal.

Furthermore, the items related to the program may be divided differently in the main terminal and the sub terminal, evenly, or in consideration of an amount of arithmetic operations of the terminals.

In addition, when the second items divided to be processed in the sub terminal is an interface, the interface being one that is not provided by the main terminal or by a program being executed, the main terminal may receive a result processed through an interface manipulation of the sub terminal and display the result on a screen.

In addition, at least some of the first items and the second items may be transmitted between the main terminal and the sub terminal according to a user's manipulation.

In addition, the method may further comprise executing by the sub terminal a command related to the first items, or executing by the main terminal a command related to the second items; and transmitting a result of execution of the command from the sub terminal to the main terminal, or a result of execution of the command from the main terminal to the sub terminal.

According to the present disclosure, it is possible to control a program using an interface of another terminal. For example, it is possible to use a touch screen to control even a program that could not be controlled using a touch screen. And accordingly, it is possible to use various interfaces and control a program efficiently.

Furthermore, according to the present disclosure, it is possible to divide arithmetic operations between terminals that place priority in portability than arithmetic operation capabilities, thereby enabling high-arithmetic operations using low specification terminals.

Not only that, according to the present disclosure, it is possible to resolve the problem of interference occurring when viewing a screen when operations are performed using just one terminal.

In addition, according to the present disclosure, even in a case where a plurality of users perform a joint project, the users may participate using each of their terminal.

### BRIEF DESCRIPTION OF THE DRAWINGS

FIG. 1 is a view illustrating a terminal 100 configured to perform a divisional control of functions, according to an exemplary embodiment of the present disclosure.

FIGS. 2a and 2b are views illustrating a system configured to perform a divisional control of functions, according to an exemplary embodiment of the present disclosure.

FIGS. 3a to 3c are views provided for explaining cases where, of the aforementioned items, menu items are divided.

FIGS. 4a to 4f are views provided for explaining operations conducted in cases where an interface is divided to be processed by terminal 2 and terminal 3, respectively, and how a menu is being changed according to the work performed.

FIGS. 5a and 5b are views provided for explaining operations conducted in cases where a division of processing is made by terminal 3 using an interface not provided in terminal 2.

FIGS. 6a and 6k are views provided for explaining a process of executing a program using a plurality of terminals.

FIGS. 7a and 7b are views provided for explaining distribution of screen and menu between terminals.

FIGS. 8a to 8d are views provided for explaining dividing of the amount of program arithmetic operations between terminals.

Throughout the drawings and the detailed description, unless otherwise described, the same drawing reference numerals will be understood to refer to the same elements, features, and structures. The relative size and depiction of these elements may be exaggerated for clarity, illustrating, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

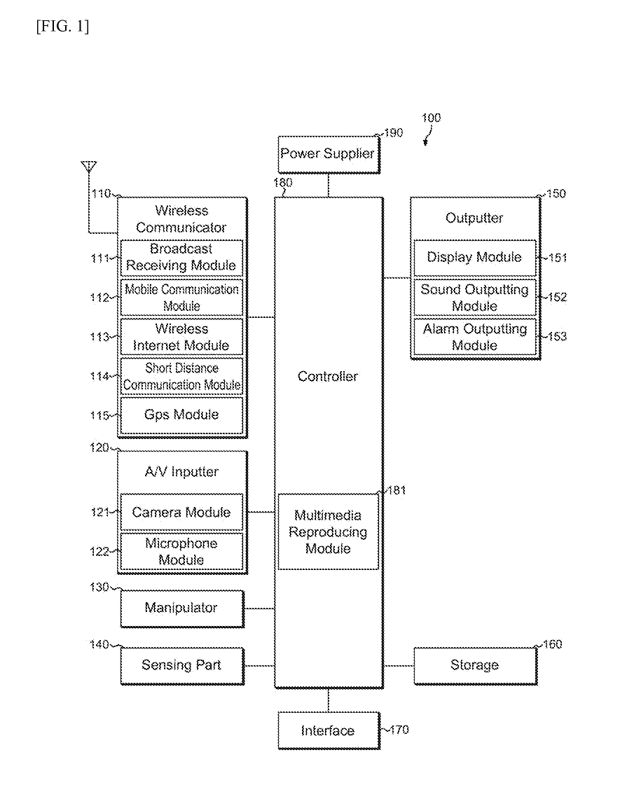

FIG. 1 is a view illustrating a terminal 100 configured to perform a divisional control of functions, according to an exemplary embodiment of the present disclosure.

The terminal 100 according to an exemplary embodiment of the present disclosure divides items for driving a program with other terminals. Herein, items for driving a program refer to an entirety of or a portion of a program being executed, and menus, tools, settings, interfaces related to the program, processings regarding the program, and sub programs regarding the program.

For example, in a case where there is menu (a) and menu (b) on one screen with terminal A driving a particular program, dividing the items for driving the program may mean displaying menu (a) on a screen of terminal A such that it may receive a user input through terminal A, and displaying menu (b) on a screen of another terminal such that it may receive a user input through the another terminal.

In addition, in a case of performing an operation using a particular program with terminal A having interface (a), dividing the items for driving the program may also mean, for an operation that may be easily performed using interface (b) provided in another terminal, performing the operation using interface (b) provided in the another terminal, whereas for an operation that may be easily performed using interface (a), performing the operation using interface (a) provided in terminal A.

Furthermore, dividing the items for driving a program may also mean having some of the arithmetic operations that should be processed by terminal A to be processed by another terminal, and transmitting only the result of the processing to terminal A.

Of course, the aforementioned examples are for brevity of explanation only, and thus besides the aforementioned, any case of dividing an entirety or a portion of a program, and menus, tools, settings, and interfaces related to the program may belong to the technical concept of the present disclosure.

Meanwhile, such a terminal 100 capable of divisional control of functions comprises a wireless communicator 110, A/V inputter 120, manipulator 130, sensing part 140, outputter 150, storage 160, interface 170, controller 180, and power supply 190.

The wireless communicator 110 is provided for the purpose of transceiving to and from base stations, other terminals, and satellites etc., and the wireless communicator 110 consists of a broadcast receiving module 111, mobile communication module 112, wireless internet module 113, short distance communication module 114, and GPS module 115.

Especially, the short distance communication module 114 may be used for dividing items for driving a program in an interlocked manner with another terminal nearby.

Such a configuration is just an example, and thus other configurative elements may be added thereto besides the aforementioned configurative elements, or only some of the aforementioned configurative elements may be provided.

The A/V inputter 120 is used for the purpose of receiving or generating an audio signal or video signal, and the A/V inputter 120 consists of a camera module 121 and a microphone module 122.

The camera module 121 is used for the purpose of photographing an object and generating an image signal, and the microphone module 122 is used for the purpose of obtaining a voice and generating or receiving a voice signal.

Such a configuration is also just an example, and thus other configurative elements may be added thereto besides the aforementioned configurations, or only some of the configurative elements may be provided.

The manipulator 130 plays a role of receiving a user's manipulation command and transmitting the received manipulation command to the controller 180 that will be explained hereinafter. Such a manipulator 130 may be embodied as a keyboard or mouse etc.

The sensing part 140 is embodied as an infrared ray sensor, gyro sensor, or illumination intensity sensor etc., and the sensing part 140 is used for the purpose of sensing infrared rays, inclination, and illumination intensity etc.

The outputter 150 is a means for providing a user with an image signal or voice signal processed by the controller that will be explained hereinafter, and the outputter 150 may consist of a display module 151, sound outputting module 152 and alarm outputting module 153.

The storage 160 is used for the purpose of storing an operating system, application program, and various settings etc. for driving a terminal according to an exemplary embodiment of the present disclosure.

The interface 170 is used for the purpose of receiving a user's manipulation besides the manipulator 130 aforementioned. Such an interface 170 may be embodied as a touch screen, touch pad, fingerprint identification module, or haptic module etc.

The controller 180 controls operations of the wireless communicator 110, A/V inputter 120, manipulator 130, sensing part 140, outputter 150, storage 160, and interface 170 so that the original roles of the terminal may be performed.

Especially, when interlocked with another terminal, the controller 180 is embodied such that divisional control of functions can be made together with the other terminal. In addition, such a controller 180 comprises a multimedia reproducing module 181 for the purpose of its original purpose, that is reproducing multimedia and an additional purpose of divisional control of functions.

The power supplier 190 receives power from outside and supplies power to each configuration of the terminal 100.

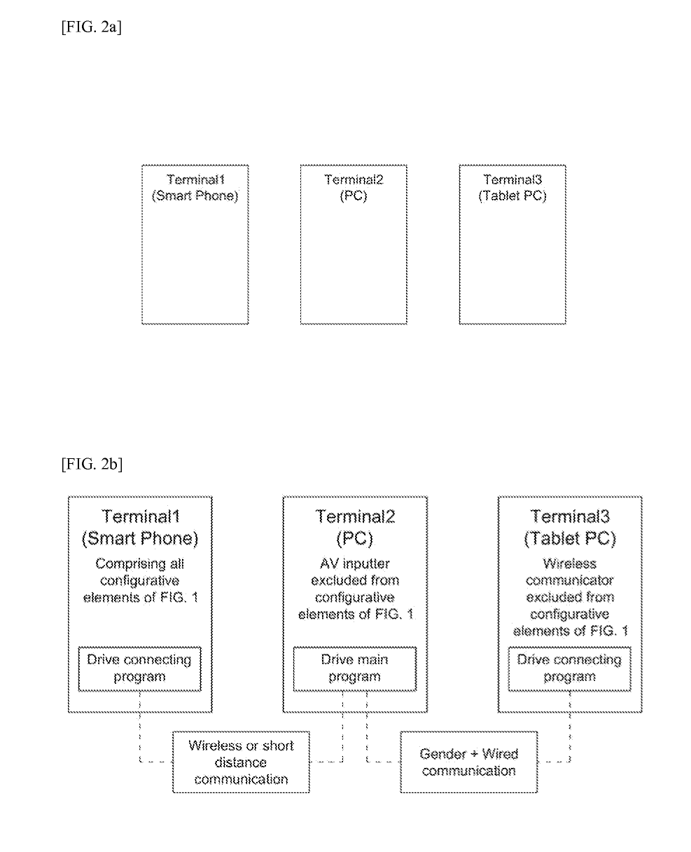

FIGS. 2a and 2b are views illustrating a system configured to perform divisional control of functions, according to an exemplary embodiment of the present disclosure.

As illustrated in FIG. 2a, the system for divisional control of functions according to the present exemplary embodiment of the present disclosure consists of terminal 1 (smart phone), terminal 2 (PC), and terminal 3 (tablet PC).

Herein, any of terminal 1, terminal 2 and terminal 3 may be the terminal of FIG. 1 aforementioned, but for brevity of explanation, hereinafter the explanation will be based on an assumption that terminal 1 is the same as the terminal of FIG. 2, that terminal 2 does not have an A/V inputter 120 of the configurative elements of terminal 1, and that terminal 3 does not have a wireless communicator 110 of the configurative elements of terminal 1.

In this case, assuming that a main program is driven in terminal 2, as illustrated in FIG. 2b, when terminal 1 and terminal 2 are interlocked to each other, and terminal 2 and terminal 3 are interlocked to each other, the main program is driven in terminal 2, and a connecting program is driven in terminal 1 and terminal 3.

Terminal 1 and terminal 2 may be interlocked to each other by general wireless communication or short distance wireless communication, whereas since terminal 3 does not have a wireless communicator 110, terminal 2 and terminal 3 may be connected to each other using a gender and be interlocked to each other.

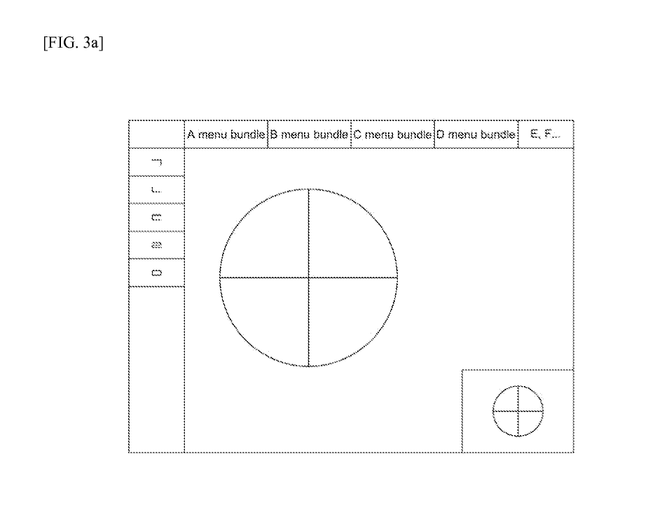

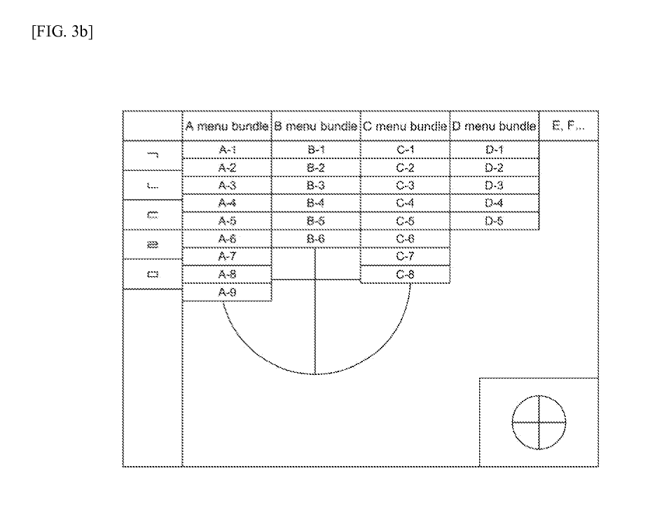

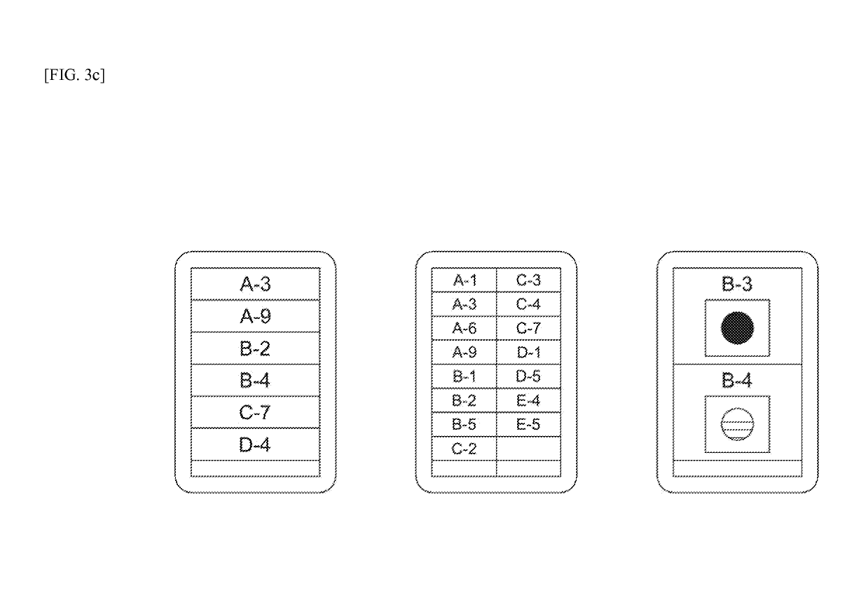

FIGS. 3a to 3c are views provided for explaining cases where, of the aforementioned items, menu items are divided. Of these views, 3a to 3b illustrate a program being executed in one device.

Referring to FIG. 3a, when a program is executed, menu bundles (A menu bundle, B menu bundle, C menu bundle, . . . ) for selecting a menu are listed at the top end, functions ( [symbol] , [symbol] , [symbol] , . . . ) for selecting functions are listed at the left side, and mini maps are listed at the bottom right end.

As can be seen from FIG. 3b, a menu bundle refers to a collection of menus having something in common of among the various menus. Of these numerous menu bundles, the menus belonging to the menu bundle selected by the user may be displayed on the screen.

In a system for divisional control of functions according to the present exemplary embodiment, in order to divide menu items to be processed by terminal 2, menu bundles (A menu bundle, B menu bundle, C menu bundle, . . . ) for menu selection may be listed in terminal 1 which is interlocked to terminal 2 and be displayed, and the user may select one of the menu bundles listed and displayed in terminal 1 that is interlocked to terminal 2.

Of course, selecting a menu bundle may not only be provided through a screen of terminal 1 but also a screen of terminal 2.

Meanwhile, terminal 1 that is interlocked to terminal 2 may not display and provide the entire menu bundles on the screen, but display and provide only subordinate menus belonging to some menu bundles (B menu bundle).

Not only that, not only the subordinate menus belonging to one menu bundle but also subordinate menus belonging to two or more menu bundles may be provided in a reduced state. Furthermore, only some of the subordinate menus belonging to one menu bundle may be provided in an expanded state.

The user becomes able to control a program by manipulating the menu bundles or subordinate menus displayed on terminal 1 that is interlocked to terminal 2, and terminal 1 becomes able to play the role of an interface for the program executed in terminal 2.

Meanwhile, the position, order, size, and scope etc. of the subordinate menus displayed on terminal 1 may be changed according user's manipulation, thereby enabling an environment convenient for user's manipulation. FIG. 3c illustrates an interface environment satisfying user's taste where the position and size have been changed.

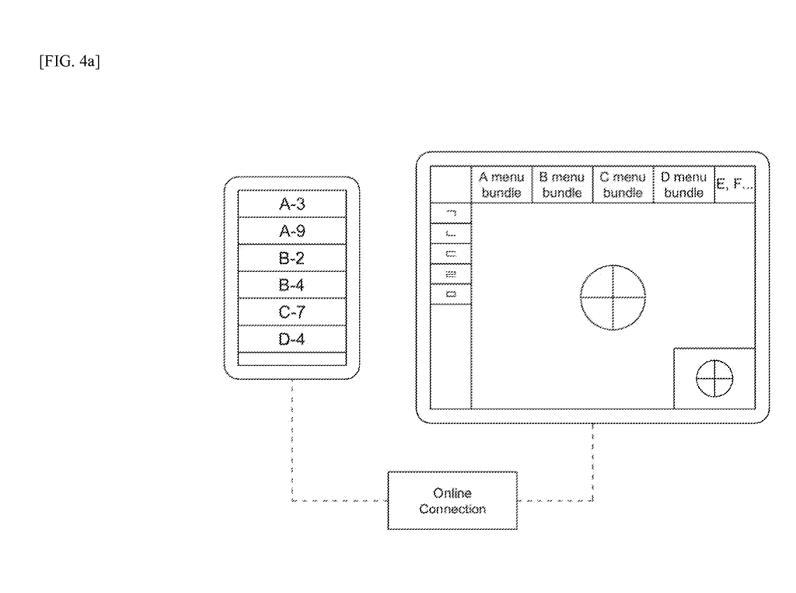

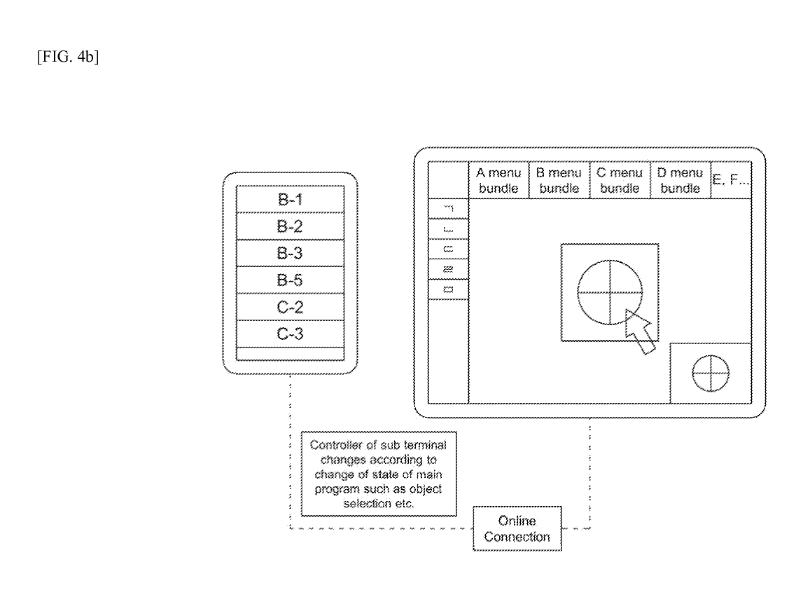

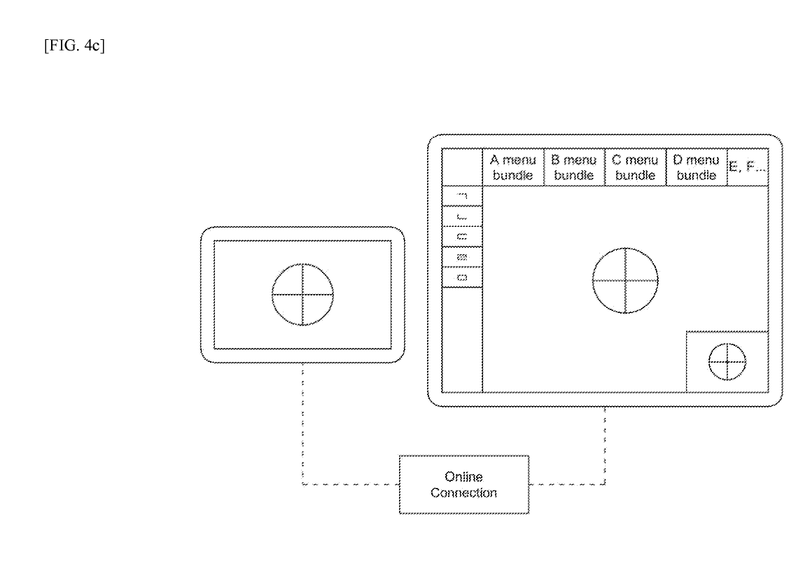

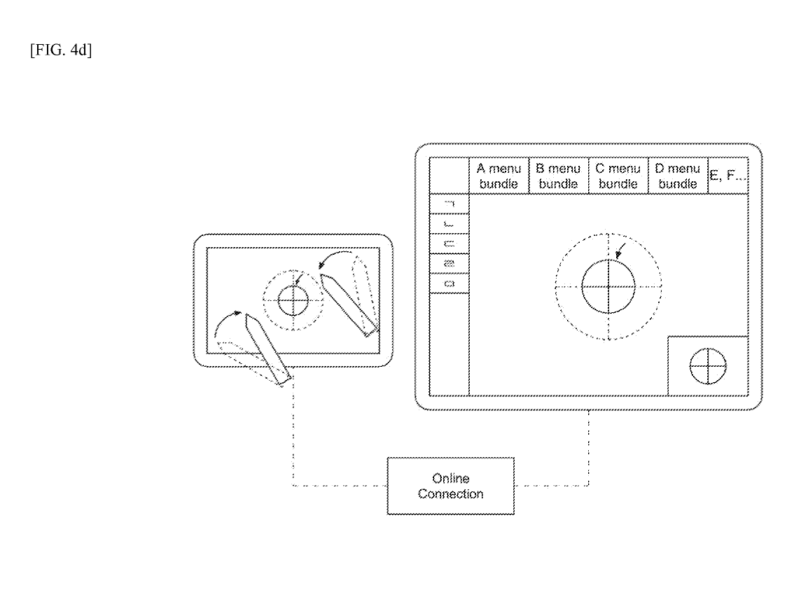

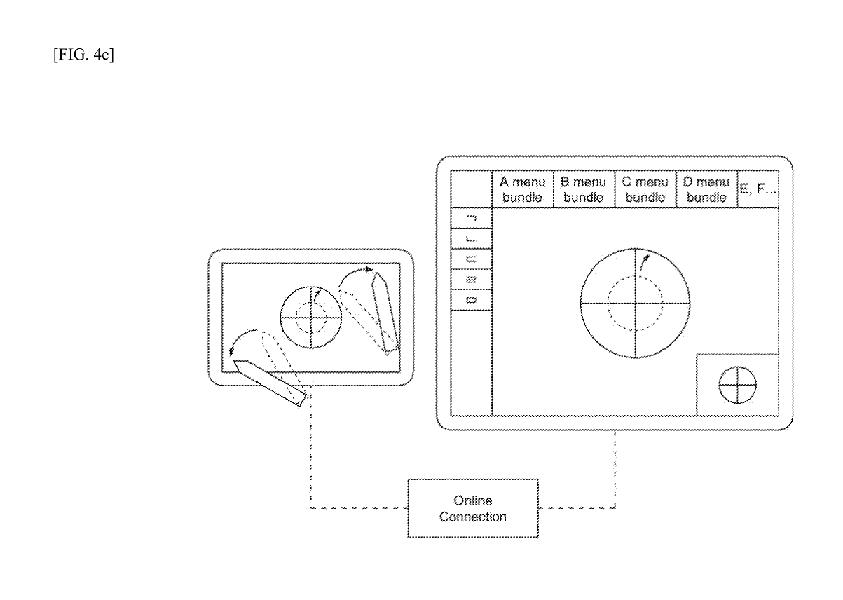

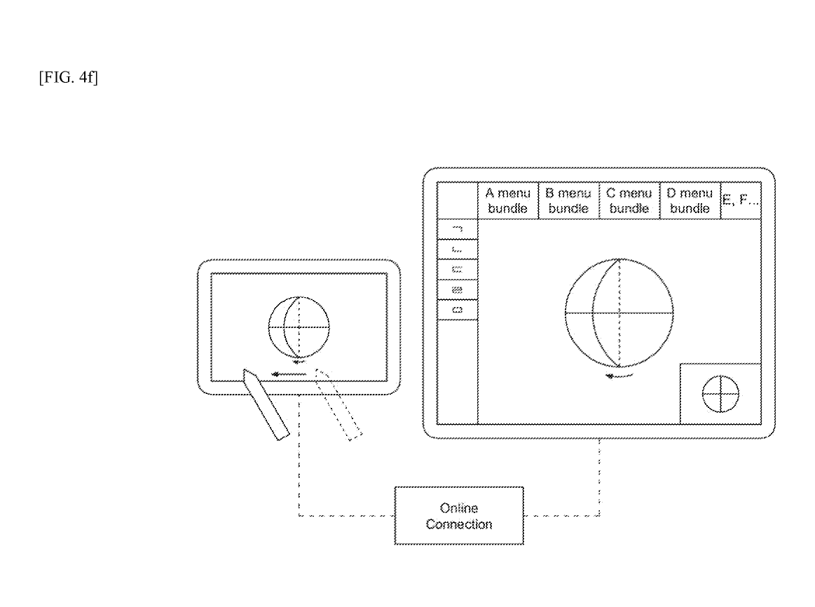

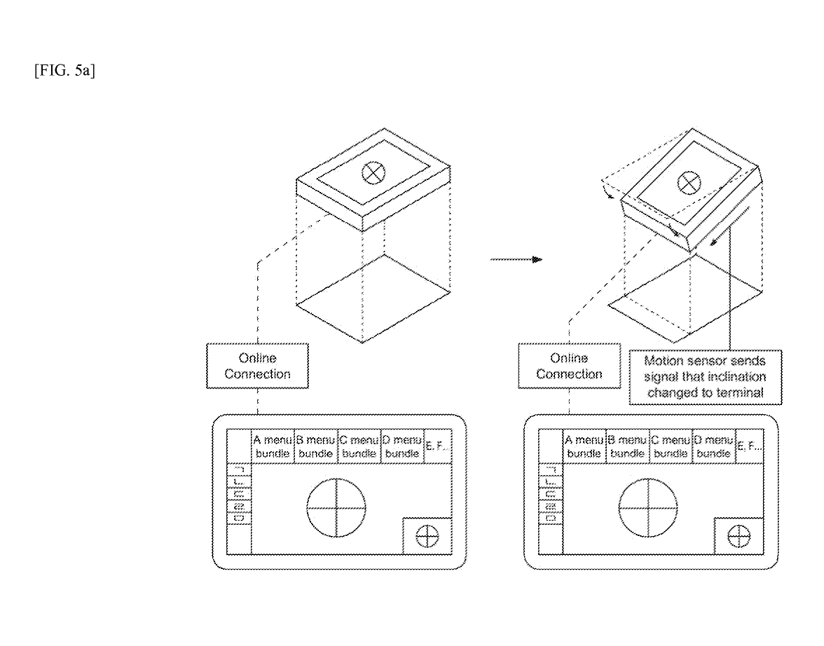

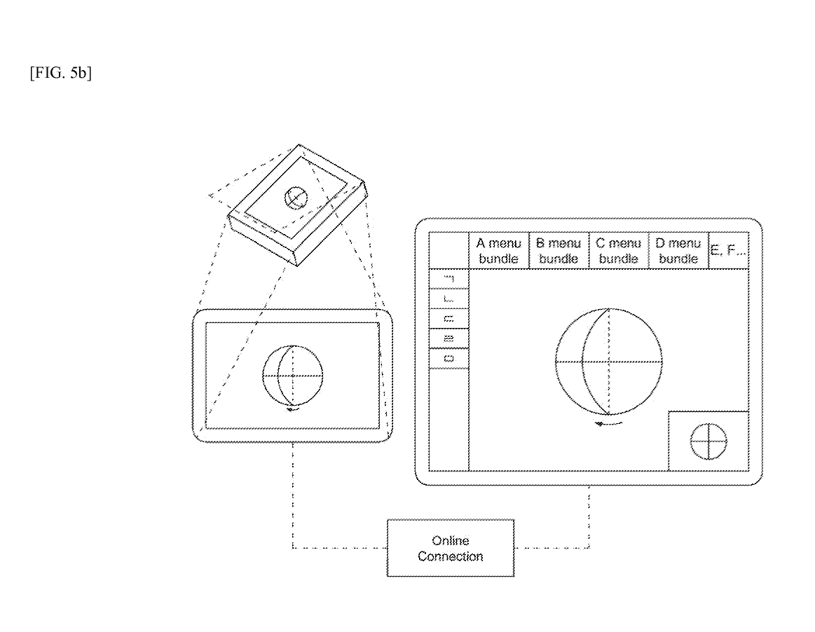

FIGS. 4a to 4f are views provided for explaining operations conducted in cases where an interface is divided to be processed by terminal 2 and terminal 3, respectively, and how a menu is being changed according to the work performed. For brevity of explanation, an assumption is made that the terminal illustrated at the left side is terminal 3, and the terminal illustrated at the right side is terminal 2, and that terminal 2 and terminal 3 are connected to each other online through wireless communication.

FIG. 4a illustrates how terminal 3 at the left side and terminal 2 at the right side are connected online to each other and interlocked to each other, thus the interface of terminal 2 being divided to be processed by terminal 3 online, under a work standby state of a program.

Herein, when an object is selected and a program state changes as illustrated in FIG. 4b, accordingly, the interface of terminal 3 interlocked to terminal 2 changes. When a manipulation on the changed interface is completed, the program falls under a work standby state again, and thus the interface of terminal 3 may be changed to a state illustrated in FIG. 4a, or the working state of terminal 2 where a main program is executed as illustrated in FIG. 4c may be displayed as it is directly on the screen of terminal 3, and the user may manipulate terminal 3 without any manipulation on terminal 2 and change the working state of the main program. Of course, these interfaces may not only be changed based on the state of the program, but may also be changed according to the user's setting.

For example, in a case of making a motion of reducing an object using a multi touch as illustrated in FIG. 4d, the size of the object displayed on terminal 3 is reduced, but the size of the object displayed on terminal 2 which is interlocked to terminal 3 may also be reduced. That is, terminal 3 proceeds with a divisional processing of a touch interface regarding terminal 2.

This may be applied to a motion of expanding an object as in FIG. 4e and rotating an object as in FIG. 4f according to the same principle, and interface functions that have not been presented may of course be performed through terminal 3.

FIGS. 5a and 5b are views provided for explaining operations in a case where a dividing for terminal 3 is made using an interface not provided in terminal 2.

With reference to FIG. 5a, in a case where terminal 2 located at the bottom end does not have a gyro sensor, or is at a state where it is difficult to use a gyro sensor, the user utilizes the gyro sensor in terminal 3 interlocked to terminal 2 as illustrated at the right side of FIG. 5a to control the object displayed on terminal 2.

For example, in a case where the user inclines terminal 3 as in the right side screen of FIG. 5a, terminal 2 interlocked to terminal 3 receives information on the direction of inclination and extent of inclination etc. from terminal 3 in signals, and controls such that the object displayed on the screen of terminal 2 rotates as illustrated in FIG. 5b. Of course, the object displayed on the screen of terminal 3 or on the screen of the additionally connected terminal 1 located at the right side could rotate as well as illustrated.

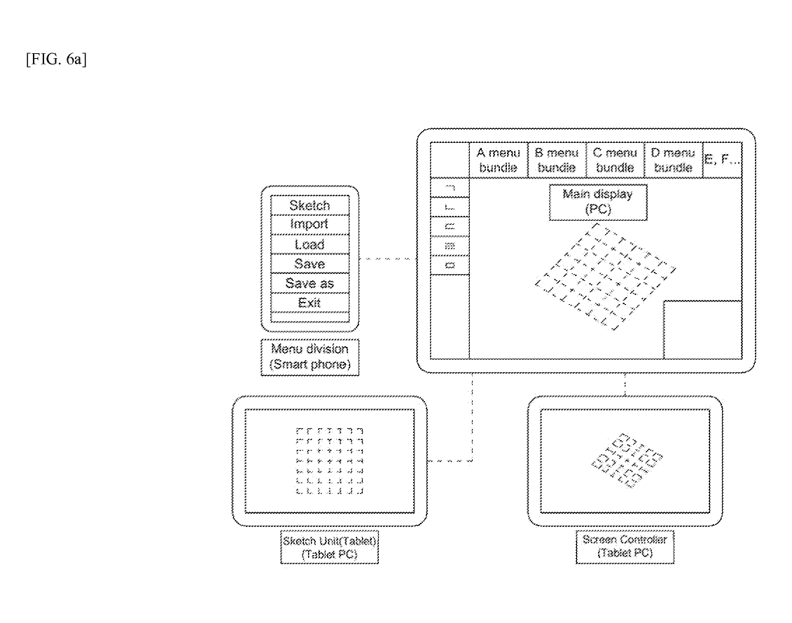

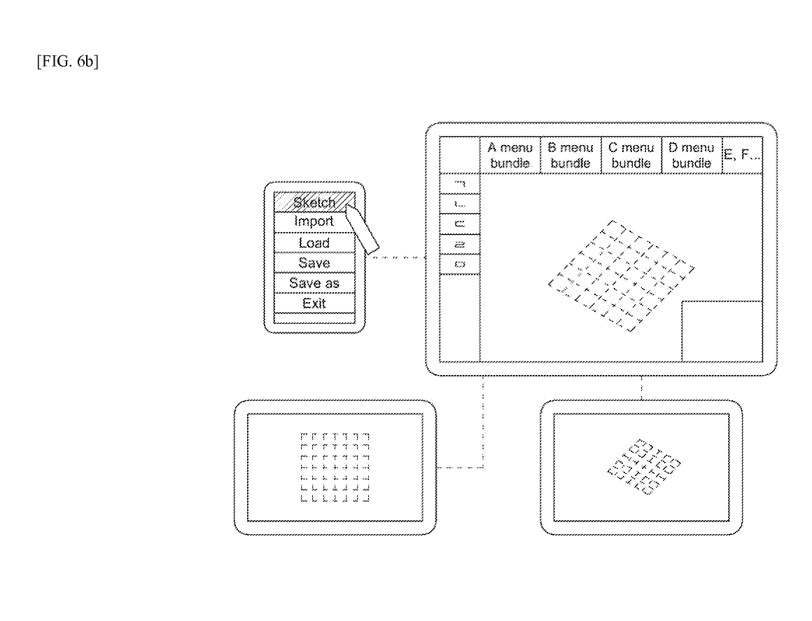

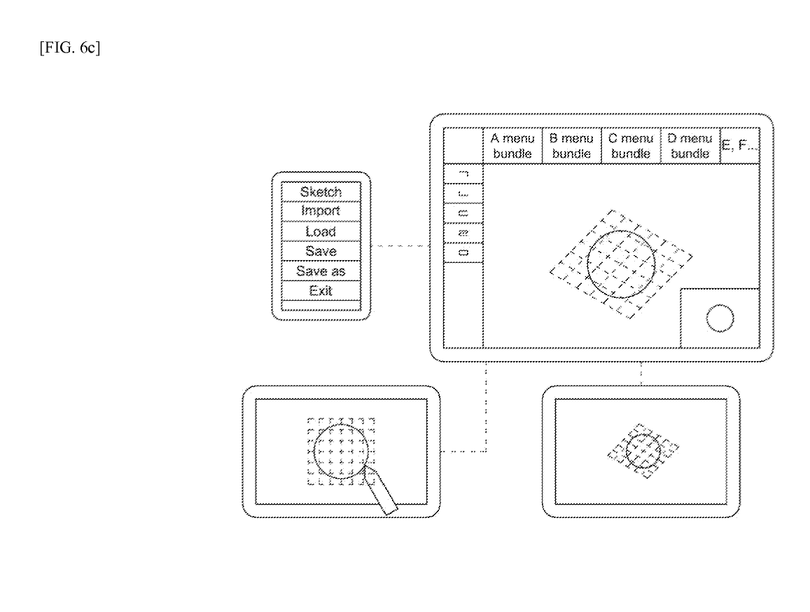

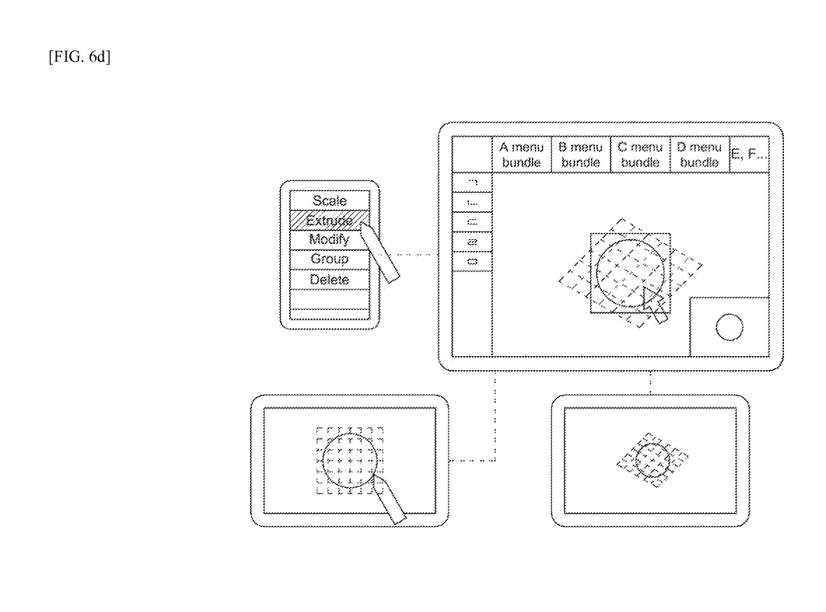

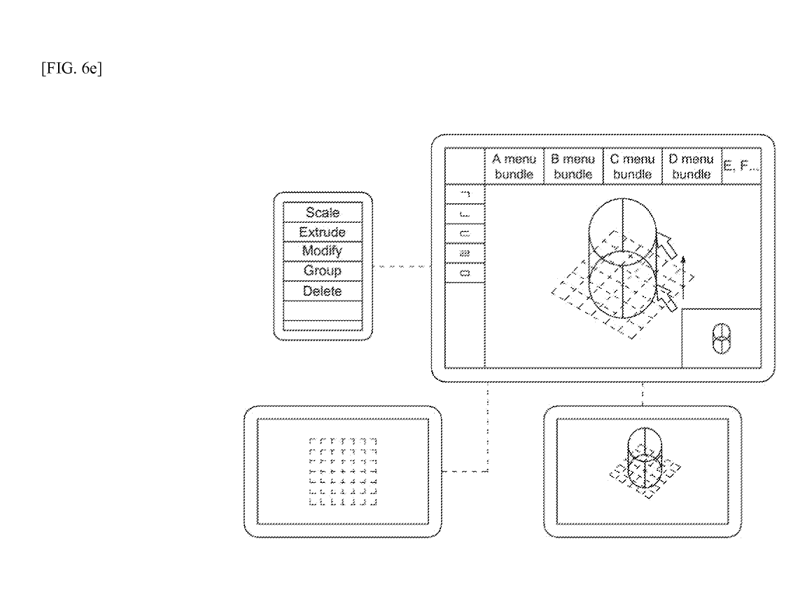

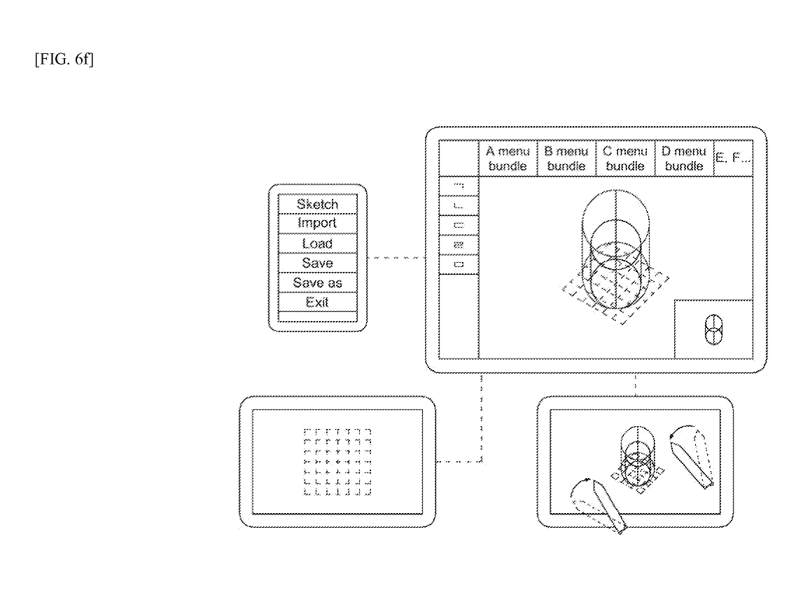

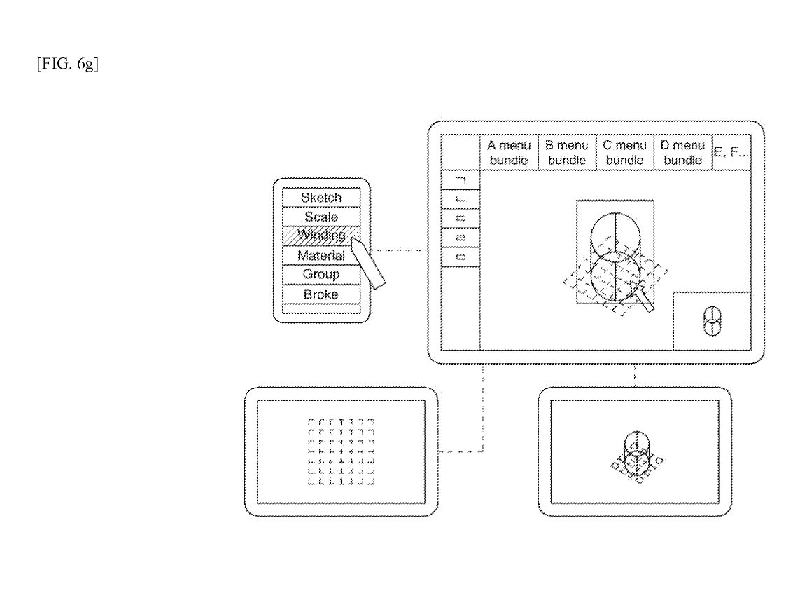

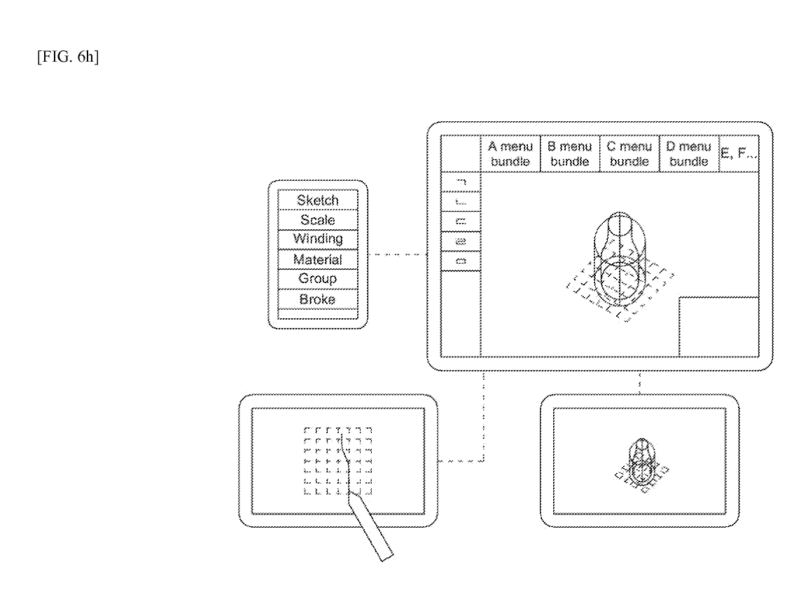

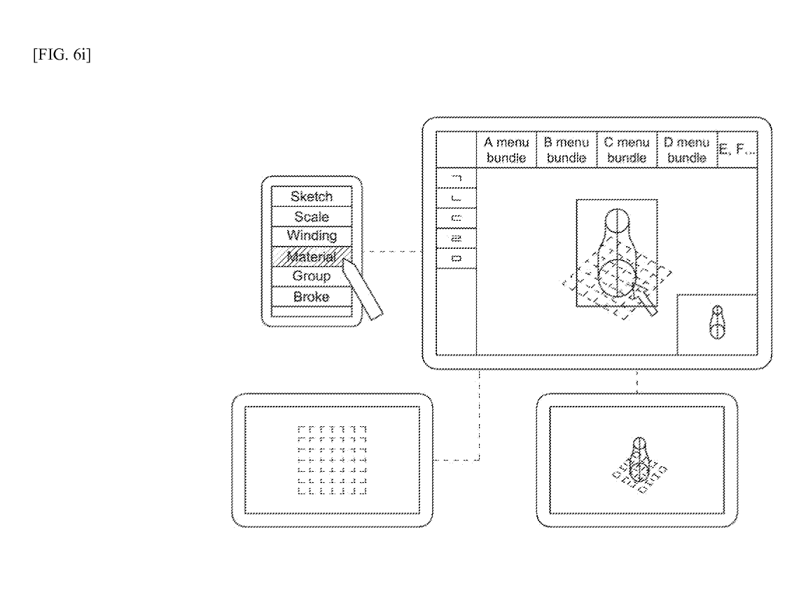

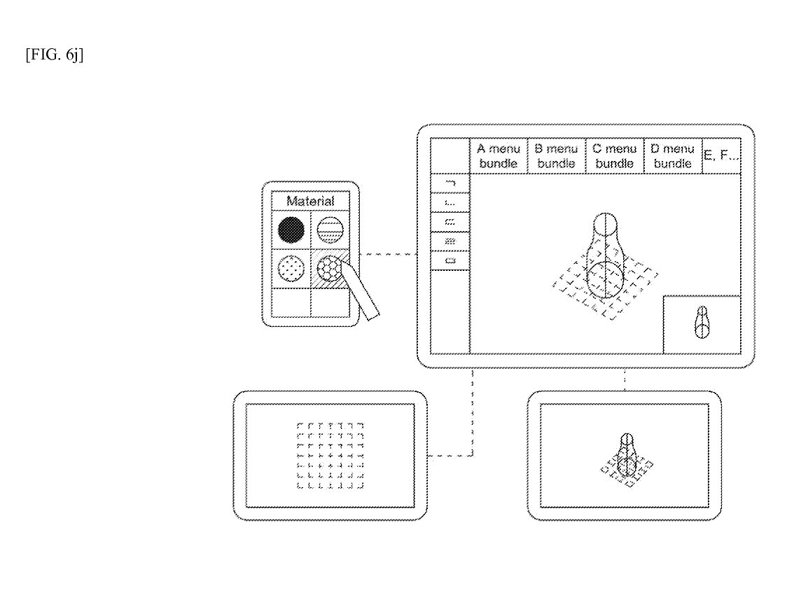

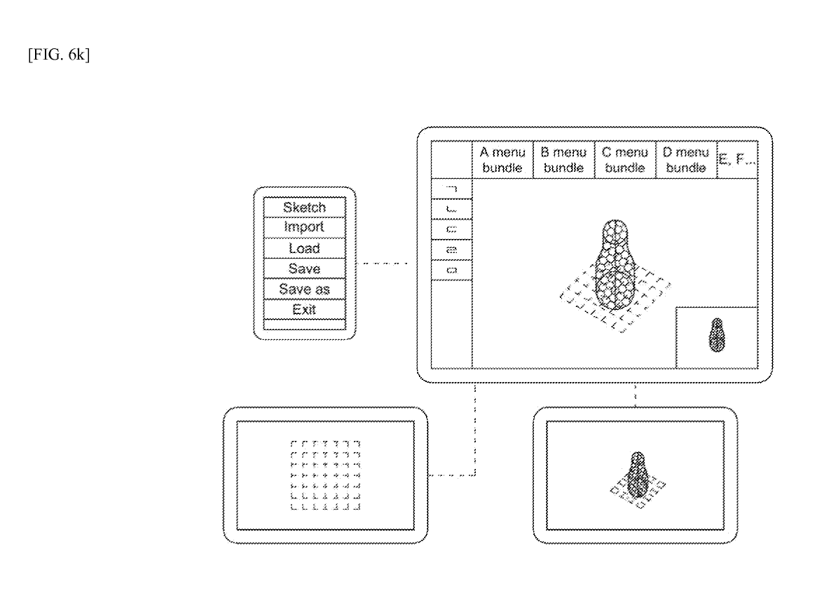

FIGS. 6a to 6k are views provided for explaining a process of executing a program using a plurality of terminals. Especially, in FIGS. 6a to 6k, explanation is made based on the process of executing a 3D design program and generating a bottle shaped figure using four terminals as an example of the program.

FIG. 6a is a view illustrating a starting screen where a 3D design program is executed using four terminals. Terminal 2 at the top right end becomes the subject of executing the 3D design program, that is the main program.

Terminal 1 at the top left end is interlocked to terminal 2 for the purpose of displaying the menus displayed on terminal 2 or the menus to be displayed on terminal 2.

As illustrated in FIG. 6b, the user may select the menus displayed on terminal 1, and enable a command corresponding to the selected menu to be executed on terminal 2.

Terminal 3 at the bottom left end is interlocked to terminal 2 for the purpose of dividing the interface for sketching.

As illustrated in FIG. 6b, when the user selects the menu ‘sketch’ through terminal 1 interlocked to terminal 2, the user may perform a ‘sketch’ operation through terminal 3 interlocked to terminal 2, as illustrated in FIG. 6c.

Meanwhile, the sketched object is displayed on not only terminal 3 where the sketch is performed, but also on the main screen of terminal 2, the mini map screen of terminal 2, and the screen of terminal 4 at the bottom left end interlocked to terminal 2. Of course, it may be embodied such that the sketched object is displayed on only some of the terminals. Specific explanation on terminal 4 will be explained hereafter.

Meanwhile, when a circle object completed through the aforementioned ‘sketch’ operation is selected in terminal 2 as illustrated in FIG. 6d, the interface of terminal 1 is changed into a menu usable in the circle object. That is, in terminal 1, menus regarding the operation lists proceedable prior to the ‘sketch’ operation regarding the circle object is changed to menus regarding operation lists proceedable after the ‘sketch’ operation regarding the circle object. Of course, selecting a circle object may be embodied to be possible through not only terminal 2 but other terminals.

Herein, when the user selects another menu in terminal 1, the user may enable an operation to be performed through terminal 2 where the main program is driven. For example, when an operation where ‘extrude’ is selected through terminal 1 as illustrated in FIG. 6d, and where a circle object is changed to a cylindrical object in terminal 2 as illustrated in FIG. 6e, the extruded object is displayed on the main screen of terminal 2 where the aforementioned ‘extrude’ operation, mini map screen of terminal 2 and terminal 4.

Herein, when the cylindrical object completed through the aforementioned ‘extrude’ operation is selected, the interface of terminal 1 may be embodied to be changed to menus usable in the cylindrical object.

Terminal 4 is interlocked to terminal 2 to perform the menus not displayed on terminal 1, or the operations that may be performed with only a touching of the screen or dragging operation. As illustrated in FIG. 6f, when a command for reducing the size is input through terminal 4, the object is reduced in the interlocked terminals. Herein, the interface of terminal 1 is changed to a program standby state screen, and when a cylindrical object completed through a series of operation is selected, the interface fo 3D object use is displayed on terminal 1 again.

Herein, in a case of intending to use a menu (‘winding’) displayed on terminal 1, ‘winding’ menu is selected in terminal 1 as illustrated in FIG. 6g, and when an operation is performed through terminal 3, the matters regarding an operation process is displayed on the interlocked terminals as illustrated in FIG. 6h, and then the matters of which operation is completed is displayed on the interlocked terminals as in FIG. 9i.

In addition, in a case of intending to select a bottle shaped 3D object for which operation has been completed and use the menu (‘material’) displayed on terminal 1, ‘material’ is selected in terminal 1 as illustrated in FIG. 6j, and if ‘material’ has additional subordinate menus, the subordinate menus are displayed on terminal 1 as in FIG. 6j.

The user may select the subordinate menus displayed on terminal 1, to enable a command to be executed related to the subordinate menus selected regarding the object selected in the interlocked terminals as in FIG. 6k.

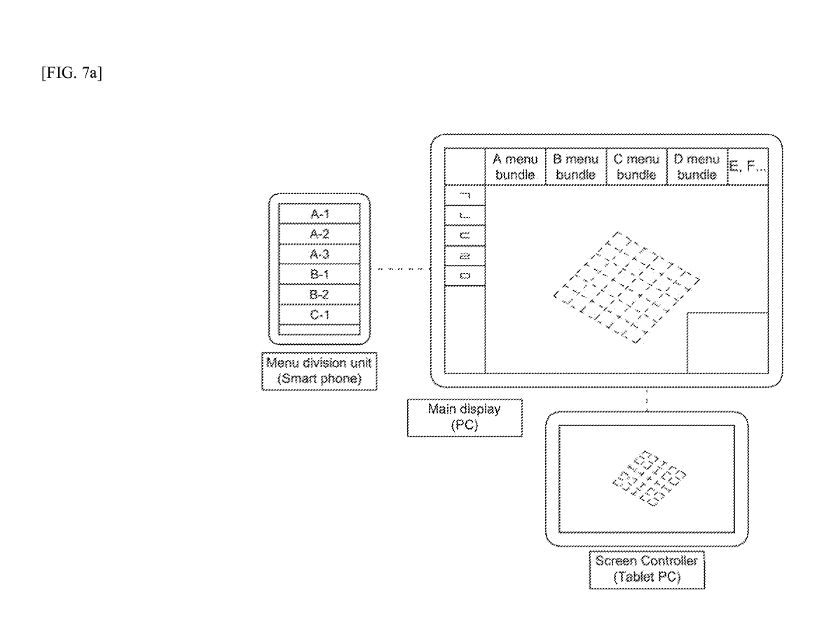

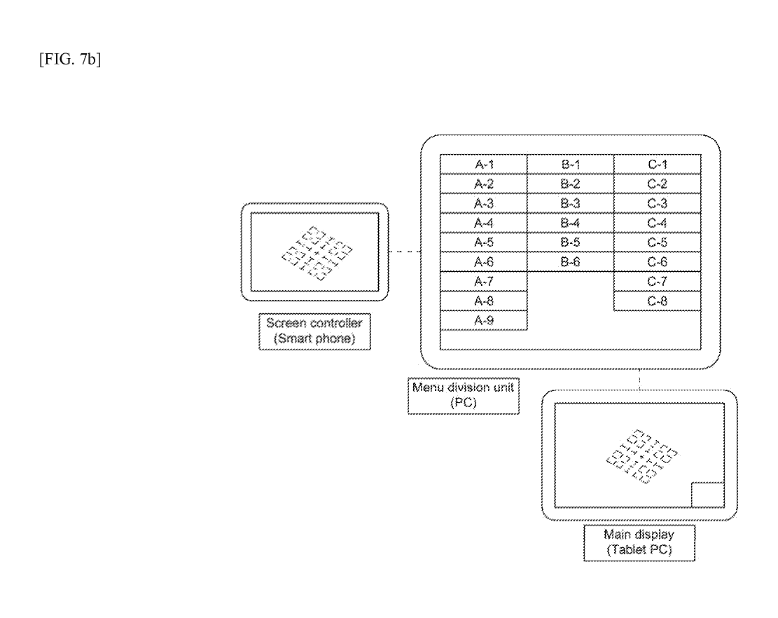

FIGS. 7a and 7b are views provided for explaining distribution of screen and menu between terminals.

As illustrated in FIG. 7a, in a case where a menu is displayed on terminal 1, a screen where the main program is driven is displayed on terminal 2, and an operation screen is displayed on terminal 3, the user may change the screen displayed on each terminal through changing of setting as illustrated in FIG. 7b, or change the menu to be displayed.

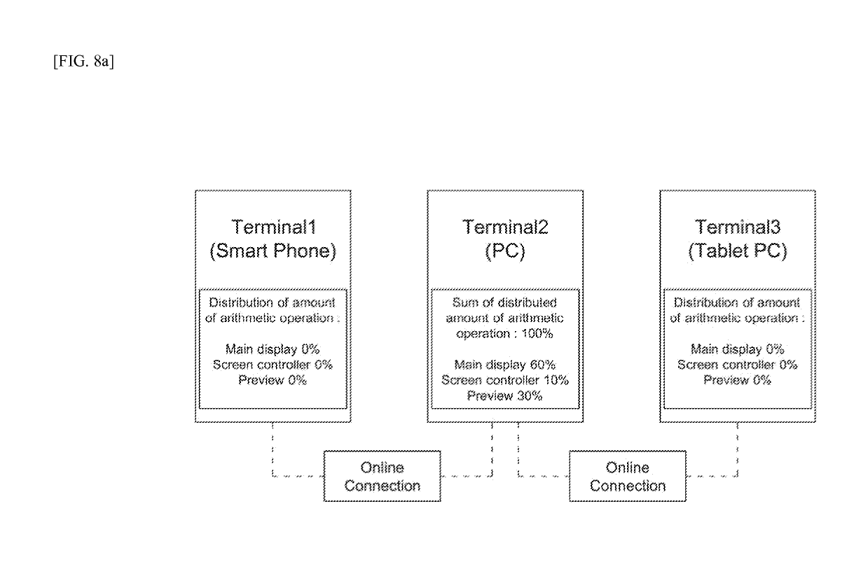

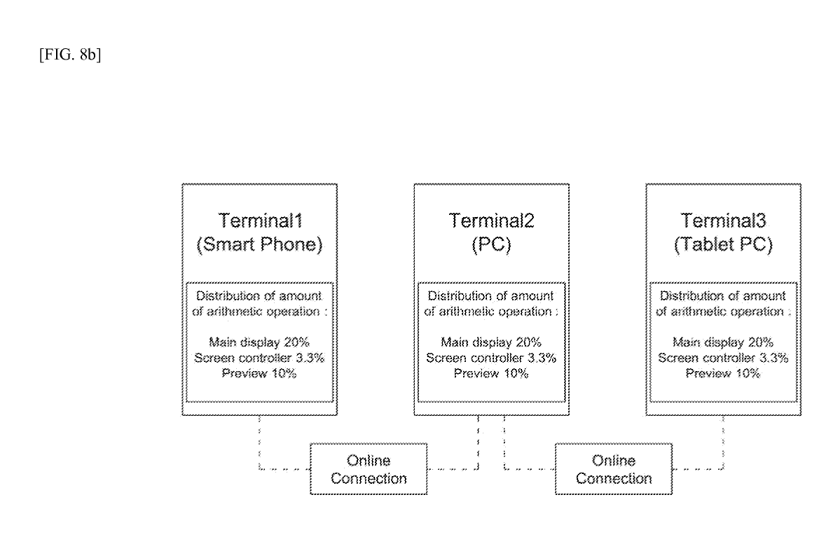

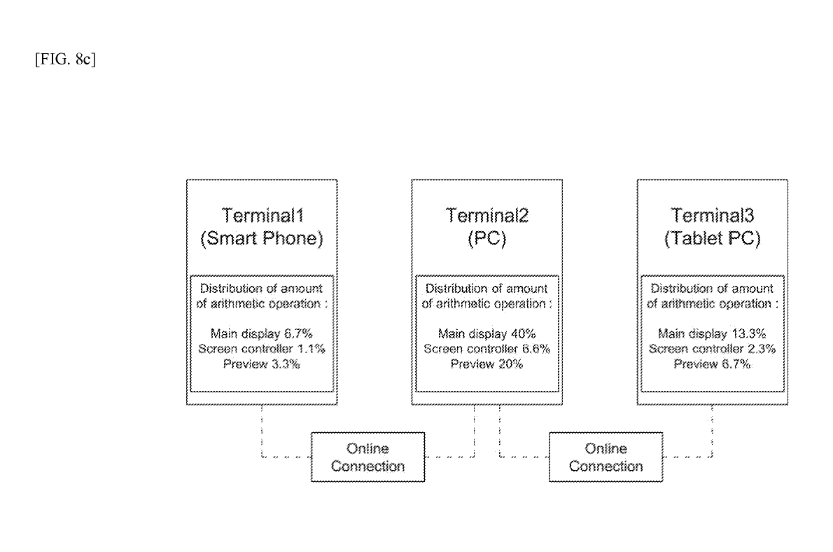

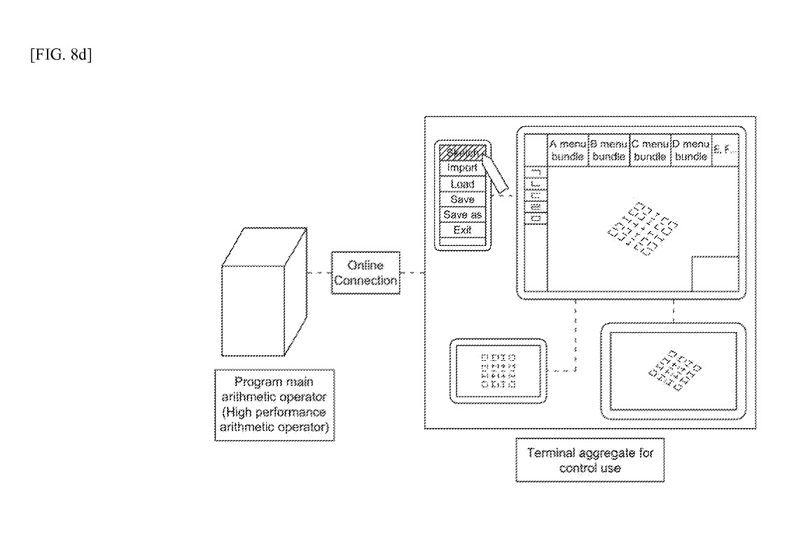

FIGS. 8a to 8d are views provided for explaining a dividing of the amount of program arithmetic operations between terminals.

In a case where the main program is driven in terminal 2, and terminal 1 and terminal 3 are interlocked to terminal 2, operations may be proceeded at a state where all arithmetic operations of the program are divided to be processed by terminal 2 as illustrated in FIG. 8a. This can be seen as a case where even if terminal 1 and terminal 3 are interlocked to each other, they do not involve in operations of each other.

Meanwhile, terminal 1 and terminal 3 may divide the total amount of arithmetic operations that would have occurred when terminal 2 proceeded the operation by itself as illustrated in FIGS. 8b to 8d, and perform the operations accordingly. Especially, FIG. 8b illustrates a case where all terminals share the same amount of arithmetic operations, FIG. 8c illustrates cases where the sharing is made according to an optimized amount of arithmetic operations, and although not illustrated, it is also possible to embody a case where the amount of arithmetic operations are shared per function.

According to an exemplary embodiment of the present disclosure, the terminals may be mutually interlocked to each other in a series type, in which case information between distanced terminals may be transmitted via a terminal located therebetween.

By another example, terminals may be interlocked by having a particular terminal (terminal 3) as a core, in which case all the information transmitted from another terminal other than terminal 3 to another terminal is transmitted via terminal 3.

By another example, all terminals may be embodied to be interlocked to one another. In this case, if all the terminals were interlocked wirelessly, it can be seen that information generated in one terminal would be broadcasted to other terminals.

By another example, terminal 1 to terminal 5 may be embodied as an aggregate for performing arithmetic operations of one program, and terminals 1, 2, 3 and terminals 4 and 5 may be embodied as an aggregate for performing arithmetic operations of different programs from one another. For example, in a case of performing an arithmetic operation regarding a program related to a graphic operation in terminal aggregate 1, an arithmetic operation may be performed regarding a program regarding a document work in terminal aggregate 2.

Meanwhile, FIG. 8d is a view presenting a method of resolving the amount of arithmetic operations in a high performance terminal as in the program main operator illustrated, when there is required a high performance terminal in executing and controlling a particular program using remote control storing and arithmetic operation technology such as cloud computing etc. In this case, it can be seen that the program main arithmetic operator performs an arithmetic operation on one program and the remaining terminal aggregate for control use performs an arithmetic operation on the other program. In sharing the amount of arithmetic operations, it can be seen that a high performance terminal such as the program main arithmetic operator is in charge of most of the amount of arithmetic operations.

Nevertheless, it will be understood that various modifications may be made. For example, suitable results may be achieved if the described techniques are performed in a different order and/or if components in a described system, architecture, device, or circuit are combined in a different matter and/or replaced or supplemented by other components or their equivalents. Accordingly, other implementations are within the scope of the following claims.

What is claimed is:

1. A program divisional controlling method by multiple terminals, the method comprising:
interlocking a main terminal and at least one sub terminal;
transmitting program information executed in the main terminal to the sub terminal;
dividing items related to the program into items to be processed by the main terminal and items to be processed by the sub terminal;
processing by the main terminal first items that are items divided to be processed by the main terminal, or processing by the sub terminal second items that are items divided to be processed by the sub terminal; and
transmitting a command related to the processed first items to the sub terminal, or transmitting a command related to the processed second items to the main terminal.

2. The method according to claim 1,
wherein the items related to the program comprise at least some of a menu, tool, setting, and interface that is usable in the program, processing regarding the program, and sub program regarding the program.

3. The method according to claim 2,
wherein, when the second items divided to be processed in the sub terminal is a menu, the menu is changed based on a state of the program executed in the sub terminal or main terminal and is displayed on a screen of the sub terminal.

4. The method according to claim 2,
wherein, when the second items divided to be processed in the sub terminal is part of a menu, the menu is displayed on a screen of the sub terminal, and the rest of the menu is displayed on a screen of the main terminal.

5. The method according to claim 1,
wherein the items related to the program are divided differently in the main terminal and the sub terminal, evenly, or in consideration of an amount of arithmetic operations of the terminals.

6. The method according to claim 1,
wherein, when the second items divided to be processed in the sub terminal is an interface, the interface being one that is not provided by the main terminal or by a program being executed, the main terminal receives a result processed through an interface manipulation of the sub terminal and displays the result on a screen.

7. The method according to claim 1,
wherein at least some of the first items and the second items are transmitted between the main terminal and the sub terminal according to a user's manipulation.

8. The method according to claim 1,
further comprising executing by the sub terminal a command related to the first items, or executing by the main terminal a command related to the second items; and
transmitting a result of execution of the command from the sub terminal to the main terminal, or a result of execution of the command from the main terminal to the sub terminal.
